(19) United States
(12) Patent Application Publication
(10) Pub. No.: US 2026/0015204 A1
(43) Pub. Date: Jan. 15, 2026

(54) METHOD AND A COMPUTING UNIT FOR DETECTING AN ENTRAPMENT SITUATION INSIDE AN ELEVATOR CAR

(71) Applicant: Kone Corporation, Helsinki (FI)

(72) Inventor: Matti MUSTONEN, Helsinki (FI)

(73) Assignee: Kone Corporation, Helsinki (FI)

(21) Appl. No.: 19/330,467

(22) Filed: Sep. 16, 2025

Related U.S. Application Data
(63) Continuation of application No. PCT/FI2023/050222, filed on Apr. 21, 2023.

(51) Int. Cl. B66B 5/00

(52) U.S. Cl. CPC B66B 5/0012; B66B 5/0031

(57) ABSTRACT

The invention relates to a method for detecting an entrapment situation inside an elevator car. The method comprising: obtaining a telemetry message after a configurable number of travels of the elevator car, wherein each telemetry message comprises load values representing a load of the elevator car during the configurable number of travels of the elevator car; observing the load values of a predefined number of the most recent travels of the elevator car to define a constant baseline load value representing the load of the elevator car without human objects inside it; comparing the load value of the last travel of the elevator car to the constant baseline load value; and detecting the entrapment situation inside the elevator car, if the result of the comparing indicates that the load value of the last travel is substantially greater than the constant baseline load value. The invention relates also to a computing unit and a detection system for detecting an entrapment situation inside an elevator car.

### CROSS-REFERENCE TO RELATED APPLICATIONS

This application is a continuation of PCT International Application No. PCT/FI2023/050222 which has an International filing date of Apr. 21, 2023, the entire contents of which are incorporated herein by reference.

### TECHNICAL FIELD

The invention concerns in general the technical field of elevator systems. Especially the invention concerns a detection of entrapment situations of elevator cars.

### BACKGROUND

The safety of passengers is one of the most important safety factors in elevator systems. For example, if an elevator system becomes inoperable, e.g. due to a failure of one or more elevator entities of the elevator system, the safety of the passengers is of utmost importance. When the elevator system becomes inoperable, the passengers may be entrapped inside the elevator cars, if the elevator car has stopped between floors or if the door(s) of the elevator car does not open, when the elevator car is stopped at a landing. Usually, in such entrapment situations, the passengers have to manually contact service providers to inform the service providers of the inoperable condition of the elevator system and to evacuate the passengers from the elevator cars. Typically, the failures of the elevator system may be detected at a remote monitoring and service center. However, information about possible entrapment situations is typically not available at the remote monitoring and service center.

There exist sensor-based solutions that may are used to detect the entrapment situations. For example, weight measuring devices may be used to detect one or more objects inside the elevator car. However, it is not possible to recognize whether the detected one or more objects are passengers or non-human objects, e.g. goods.

Thus, there exists a need to develop further solutions to detect entrapment situations of elevator cars.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, a computing unit, and a detection system for detecting an entrapment situation inside an elevator car. Another objective of the invention is that the method, the computing unit, and the detection system for detecting an entrapment situation inside an elevator car improve safety of an elevator system.

The objectives of the invention are reached by a method, a computing unit, and a detection system as defined by the respective independent claims.

According to a first aspect, a method for detecting an entrapment situation inside an elevator car is provided, wherein the method comprises: obtaining a telemetry message after a configurable number of travels of the elevator car, wherein each telemetry message comprises load values representing load of the elevator car during the configurable number of travels of the elevator car; observing the load values of a predefined number of the most recent travels of the elevator car to define a constant baseline load value representing the load of the elevator car without human objects inside it; comparing the load value of the last travel of the elevator car to the constant baseline load value; and detecting the entrapment situation inside the elevator car, if the result of the comparing indicates that the load value of the last travel is substantially greater than the constant baseline load value.

The method may further comprise generating at least one service need comprising an indication of the detected entrapment situation inside the elevator car.

The load value may comprise a mass of the load of the elevator car or a parameter representing the mass of the load of the elevator car.

The parameter may comprise power data representing electrical power supplied to a hoisting motor configured to move the elevator car, torque and current data representing torque and current of the hoisting motor during a constant speed phase of the travel of the elevator car, or energy data representing accumulated power supplied to the hoisting motor during the travel of the elevator car.

Each telemetry message may further comprise stopping location data representing locations in an elevator shaft, where the elevator car has stopped at the end of the configurable number of travels of the elevator car.

Alternatively or in addition, the method may further comprise: receiving an inoperable notification indicating an inoperable condition of the elevator car; and observing the load values of the predefined number of the most recent travels of the elevator car to define the constant baseline load value representing the load of the elevator car without human objects inside it, in response to receiving the inoperable notification.

The inoperable notification may be a fault telemetry message comprising a fault notification indicating the inoperable condition of the elevator car.

The predefined number of the most recent travels of the elevator car may be defined based on a certain time window preceding the last travel of the elevator car, a predefined constant number of the most recent travels of the elevator car, or a varying number of the most recent travels of the elevator car. The defining the constant baseline load value may comprise: selecting at least a predefined number of minimum load values from among the observed load values of the predefined number of the most recent travels of the elevator car; verifying that the selected minimum load values are within a predefined error margin of each other; and defining the constant baseline load value based on the verified selected minimum load values.

According to a second aspect, a computing unit for detecting an entrapment situation inside an elevator car is provided, wherein the computing unit comprises: a processing unit comprising one or more processors, and a memory unit comprising one or more memories storing a computer program code, wherein one or more memories and the computer program code are configured to, with the one or more processors, cause the computing unit to perform: obtain a telemetry message after a configurable number of travels of the elevator car, wherein each telemetry message comprises load values representing a load of the elevator car during the configurable number of travels of the elevator car; observe the load values of a predefined number of the most recent travels of the elevator car to define a constant baseline load value representing the load of the elevator car without human objects inside it; compare the load value of the last travel of the elevator car to the constant baseline load value; and detect the entrapment situation inside the elevator car, if the result of the comparing indicates that the load value of the last travel is substantially greater than the constant baseline load value.

The computing unit may further be configured to generate at least one service need comprising an indication of the detected entrapment situation inside the elevator car.

The load value may comprise a mass of the load of the elevator car or a parameter representing the mass of the load of the elevator car.

The parameter may comprise power data representing electrical power supplied to a hoisting motor configured to move the elevator car, torque and current data representing torque and current of the hoisting motor during a constant speed phase of the travel of the elevator car, or energy data representing accumulated power supplied to the hoisting motor during the travel of the elevator car.

Each telemetry message may further comprise stopping location data representing locations in an elevator shaft, where the elevator car has stopped at the end of the configurable number of travels of the elevator car.

Alternatively or in addition, the computing unit may further be configured to: receive an inoperable notification indicating an inoperable condition of the elevator car; observe the load values of the predefined number of the most recent travels of the elevator car to define the constant baseline load value representing the load of the elevator car without human objects inside it, in response to receiving the inoperable notification.

The inoperable notification may be a fault telemetry message comprising a fault notification indicating the inoperable condition of the elevator car.

The predefined number of the most recent travels of the elevator car may be defined based on a certain time window preceding the last travel of the elevator car, a predefined constant number of the most recent travels of the elevator car, or a varying number of the most recent travels of the elevator car.

The defining the constant baseline load value may comprise that the computing unit may be configured to: select at least a predefined number of minimum load values from among the observed load values of the predefined number of the most recent travels of the elevator car; verify that the selected minimum load values are within a predefined error margin of each other; and define the constant baseline load value based on the verified selected minimum load values.

According to a third aspect, a detection system for detecting an entrapment situation inside an elevator car is provided, wherein the detection system comprises: an elevator control system, and a computing unit as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator environment, in which a detection system for detecting an entrapment situation inside an elevator car may be implemented.

FIGS. 2A to 2C illustrate schematically examples of the detection system for detecting an entrapment situation inside the elevator car.

FIG. 3 illustrates schematically an example of a method for detecting an entrapment situation inside the elevator car.

FIG. 4 illustrates schematically an example of defining a constant baseline load value.

FIGS. 5A and 5B illustrate schematically examples of obtained telemetry messages of a predefined number of the most recent travels of the elevator car.

FIG. 6 illustrates schematically an example of components of a computing unit.

### DESCRIPTION OF THE EXEMPLIFYING EMBODIMENTS

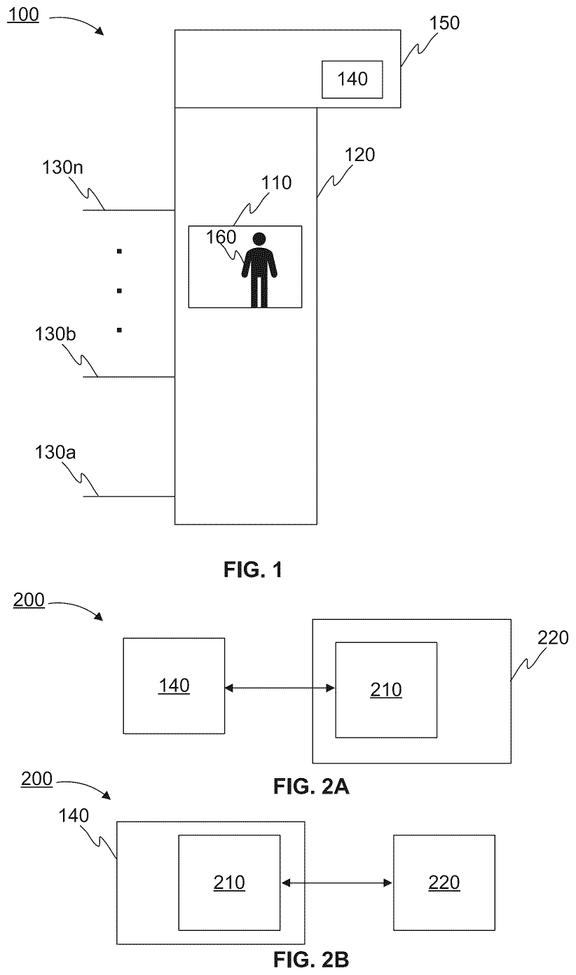

FIG. 1 illustrates schematically an example of an elevator environment, e.g. an elevator system 100, in which a detection system 200 for detecting an entrapment situation inside an elevator car 110 may be implemented. The elevator system 100 comprises at least one elevator car 110 configured to travel along a respective elevator shaft 120 between a plurality of floors, i.e. landings, 130a-130n, and an elevator control system 140. The elevator system 100 may also form an elevator group, i.e. group of two or more elevator cars 110 each travelling along a separate elevator shaft 120 configured to operate as a unit serving the same landings 130a-130n. The elevator system 100 further comprises a hoisting system comprising a hoisting motor configured to drive the at least one elevator car 110 along the respective elevator shaft 120 between the floors 130a-130n. For sake of clarity the hoisting system is not shown in FIG. 1. The elevator system 100 may further comprise one or more known elevator related entities, e.g. user interface devices, elevator doors, safety circuit and devices, and/or elevator brakes, etc., which are not shown in FIG. 1 for sake of clarity.

The elevator control system 140 is configured to at least control the operations of the elevator system 100. The elevator control system 140 may locate inside a machine room 150 (as illustrated in the example of FIG. 1) or at one of the floors 130a-130n. The elevator control system 140 is communicatively coupled to the other entities of the elevator system 100. The communication between the elevator control system 140 and the other entities of the elevator system 100 may be based on one or more known communication technologies, either wired or wireless. The implementation of the elevator control system 140 may be done as a stand-alone control entity or as a distributed control environment between a plurality of stand-alone control entities, such as a plurality of servers, providing distributed control resource.

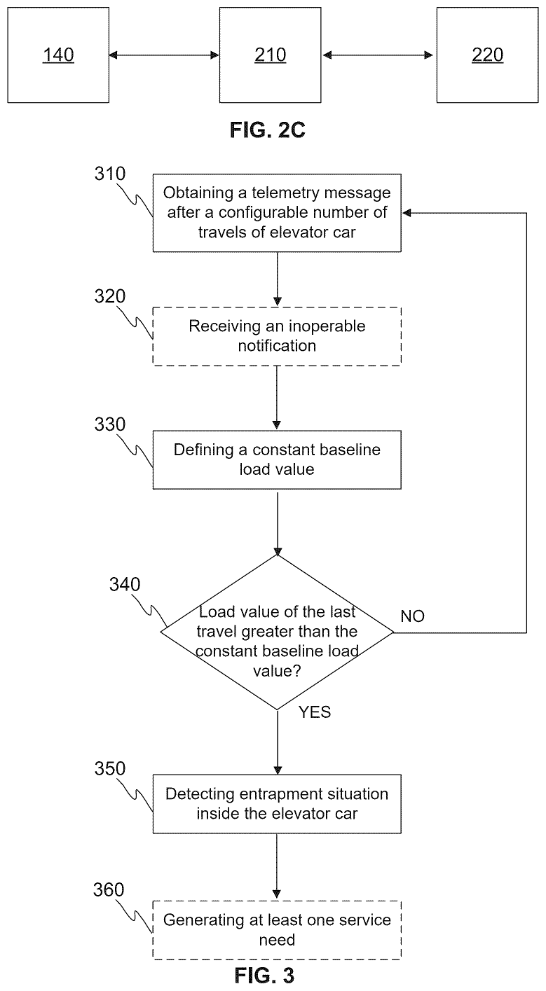

FIG. 2A illustrates schematically an example of the detection system 200 for detecting the entrapment situation inside the elevator car 110. The detection system 200 comprises the elevator control system 140 and a computing unit 210. The elevator control system 140 is communicatively coupled to the computing unit 210, either directly or indirectly. The communication between the elevator control system 140 and the computing unit 210 may be based on one or more known communication technologies, either wired or wireless. The indirect communication between the elevator control system 140 and the computing unit 210 may be performed via a connectivity module, e.g. a gateway device. The computing unit 210 may be implemented as a local computing unit locating at the elevator system 100, i.e. as an on-site computing unit, or as a remote computing unit locating remote from the elevator system 100, i.e. as an off-site computing unit. The computing unit 210 may be a part of, i.e. embedded inside, a remote monitoring system 220, e.g. the computing unit 210 may be comprised by the remote monitoring system 220 as illustrated in the example of FIG. 2A. Alternatively, the computing unit 210 may be a part of, i.e. embedded inside, the elevator control system 140, e.g. the computing unit 210 may be comprised by the elevator system 140 as illustrated in FIG. 2B, which illustrates schematically another example of the detection system 200. The computing unit 210 comprised by the elevator system 140 may be communicatively coupled to the remote monitoring system 220. Alternatively, the computing unit 210 may be a separate computing unit (i.e. a separate unit from the remote monitoring system 220 and from the elevator control system 140) communicatively coupled to the remote monitoring system 220 as illustrated in FIG. 2B, which illustrates schematically yet another example of the detection system 200. The communication between the computing unit 210 and the remote monitoring system 220 may be based on one or more known communication technologies, either wired or wireless. According to yet another example, the computing unit 210 may be a part of, i.e. embedded inside, any other device or system, e.g. an edge device arranged to the elevator system 110, for example to the elevator car 110, e.g. on top of the elevator car 110, or in the machine room 150. The remote monitoring system 220 may for example be a cloud server, a service center, a maintenance center, or a data center. Some non-limiting examples of the computing unit 210 may comprise a cloud-based computing unit, a server, a network of computing devices, etc.

Next an example of a method for detecting an entrapment situation inside the elevator car 110 is described by referring to FIG. 3. FIG. 3 schematically illustrates the method as a flow chart. The method is described for detecting an entrapment situation inside one elevator car 110, but an entrapment situation(s) inside more than one elevator car 110 of the elevator system 100 may be detected similarly as will be described for the one elevator car 110.

At a step 310, the computing unit 210 obtains from the elevator control system 140 a telemetry message, e.g. a car event (CE) telemetry message, after a configurable, i.e. a predefined, number of travels of the elevator car 110. The configurable number of travels of the elevator car 110 is at least one. Preferably, the computing unit 210 may obtain from the elevator control system 140 a telemetry message after each travel of the elevator car 110. In other words, preferably the configurable number of travels of the elevator car 110 may be one. The configurable number of travels of the elevator car 110 may be adjustable. For example, the configurable number of travels of the elevator car 110 may first be set to one, i.e. a telemetry message is obtained after each travel of the elevator car 110, and later the configurable number of travels of the elevator car 110 may be adjusted to two, i.e. a telemetry message is obtained after every second travel of the elevator car. One travel of the elevator car 110 comprises a movement of the elevator car 110 from a departure floor to a destination floor. Each telemetry message comprises load values representing a load of the elevator car 110 during the configurable number of travels of the elevator car 110. For example, if the telemetry message is received after each travel of the elevator car 110, each telemetry message comprises a load value of said one travel of the elevator car 110. According to another example, if the telemetry message is received after every second travel of the elevator car 110, each telemetry message comprises the load values of said two travels of the elevator car 110. The load value may for example be a mass of the load of the elevator car 110, or any other parameter representing the mass of the load of the elevator car 110, from which the mass of the load of the elevator car 110 may be defined, e.g. calculated and/or estimated. The mass of the load of the elevator car 110 may for example be provided, e.g. measured, by using a load weighing device, e.g. a floor scale, arranged to the elevator car 110, or by using a machinery load weighing device. The load value comprised in the telemetry messages may for example comprise directly the mass of the load of the elevator car 110. Alternatively, the load value comprised in the telemetry messages may comprise raw measurement data from which the mass of the load of the elevator car 110 may be defined, e.g. by the computing unit 210, by taking into account fixed elevator structures, e.g. by removing a fixed structure load value representing the mass of the fixed elevator structures. The fixed elevator structures, which need to be taken into account may depend on the used load weighing device. For example, if the floor scale is used, the floor of the elevator car 110 needs to be taken into account. According to another example, if the machinery load weighing device is used, the elevator car 110 itself, a counterweight, and suspension ropes needs to be taken into account. The fixed structure load value may be predefined, e.g. based on historical data. According to a non-limiting example, the mass of the load of the elevator car 110 may be expressed as a numerical value, e.g. in kilograms, or as a percentage value relative to a nominal load of the elevator car 110.

The parameter representing the mass of the load of the elevator car 110 may for example be a power data, torque and current data, or energy data. The power data may for example represent electrical power supplied to the hoisting motor configured to move the elevator car 110 along the elevator shaft 120. The electrical power indicates substantially accurately the mass of the load of the elevator car 110 assuming the balancing remains constant (as normally is), but the direction needs to be taken into account, as the electrical power is different with the same load inside the elevator 110 when travelling upwards and downwards. Thus, the power data may further comprise the direction of the travel of the elevator car 110. The torque and current data may for example represent the torque and current of the hoisting motor during constant speed phase of the travel of the elevator car 110. The electrical power and thus also the mass of the load of the elevator car 110 may be defined based on the torque and current data. The energy data may represent an accumulated power, i.e. energy, supplied to the hoisting motor during the travel of the elevator car 110. As the energy is integral of the power, when the elevator car 110 is travelling longer distance and thus having a longer nominal speed area with the load, more energy shall be consumed due to integration. Therefore, the distance of the travel of the elevator car 110 and the direction of the travel of the elevator car 110 need to be taken into account. Thus, the energy data may further comprise the distance of the travel of the elevator car 110 and the direction of the travel of the elevator car 110. The electrical power and thus also the mass of the load of the elevator car 110 may be defined based on the energy data.

Each telemetry message may further comprise stopping location data representing locations in the elevator shaft 120, where the elevator car 110 has stopped at the end of the configurable number of travels of the elevator car 110. For example, if the telemetry message is received after each travel of the elevator car 110, each telemetry message comprises stopping location data representing the location in the elevator shaft 120, where the elevator car 110 has stopped at the end of said travel of the elevator car 110. According to another example, if the telemetry message is received after every second travel of the elevator car 110, each telemetry message comprises stopping location data representing locations in the elevator shaft 120, where the elevator car 110 has stopped at the end of said two travels of the elevator car 110. The location may be one of the floors 130a-130n of the elevator shaft 120, e.g. a destination floor of said travel of the elevator car 110, or a location between two consecutive floors 130a-130n, if the destination floor has not been reached, i.e. the elevator car 110 has been stopped between the floors 130a-130n. The computing unit 210 may store the obtained telemetry messages and/or the context of the obtained telemetry messages, e.g. into a memory unit 620 of the computing unit 210 or a database.

At a step 330, the computing unit 210 observes the load values of a predefined number of the most recent travels of the elevator car 110 to define a constant baseline load value representing the load of the elevator car 110 without human objects 160 inside it. As it is highly unlikely that the load of the elevator car 110 will remain constant with one or more human objects, e.g. one or more passengers, travelling inside the elevator car 110 only, the load values being substantially constant may be considered to indicate the load of the elevator car 110 without the human objects 160 inside it. Thus, the constant baseline load value may for example be defined based the load values being substantially constant. The definition of the constant baseline load value is discussed further later in this application. According to an example, the computing unit 210 may observe the load values in response to receiving from the elevator control system 140 an inoperable notification indicating an inoperable condition of the elevator car 110. This is illustrated with an optional step 320 in the example of FIG. 3. The inoperable condition of the elevator car 110 may be caused by one or more failures in the elevator system 110. In the inoperable condition of the elevator car 110, the elevator car 110 may for example have been stopped between floors 130a-130n, i.e. between two consecutive floors, or the doors of the elevator car 110 does not open, when the elevator car 110 is stopped at a floor causing a possible entrapment situation. In the entrapment situation human objects, e.g. passengers, 160 inside the elevator car 110 may be entrapped inside the elevator car 110. The inoperable notification may for example be a fault telemetry message received from the elevator control system 140, wherein said fault telemetry message comprises a fault notification indicating the inoperable, i.e. fault condition of the elevator car 110. The elevator control system 140 sends the fault telemetry message, when the inoperable condition of the elevator car 110 is detected. Typically, the fault telemetry message is sent immediately after detecting the inoperable condition, but there may also exist a predefined delay between the detection of the inoperable condition of the elevator car 110 and sending the fault telemetry message. In case there is no non-human objects, e.g. goods, inside the elevator car 110 during the predefined number of the most recent travels, the defined constant baseline load value may represent the load of the empty elevator car 110, i.e. the elevator car 110 without human objects and non-human objects. Alternatively, in case there are one or more non-human objects inside the elevator car 110 constantly during the predefined number of the most recent travels, the defined constant baseline load value may represent a constant mass of the one or more non-human objects travelling in the elevator car 110. The predefined number of the most recent travels of the elevator car 110 may for example be defined based on a certain time window preceding the last travel of the elevator car 110, a predefined constant number of the most recent travels of the elevator car 110, or a varying number of the most recent travels of the elevator car. The last travel of the elevator car 110 is the latest, i.e. the most recent, travel of the elevator car 110 after which the most recent telemetry message is obtained. According to an example, if the inoperable notification is received at the step 320, the last travel of the elevator car may be the latest, i.e. the most recent, travel of the elevator car 110 preceding the inoperable notification, i.e. the travel of the elevator car 110 after which the inoperable notification is received. According to non-limiting examples, the certain time window preceding the last travel of the elevator car 110 may be 10 minutes, 15 minutes, half an hour, or one hour, etc. The duration of the time window may be defined based on a usage rate of the elevator car 110. For example, if the usage rate of the elevator car 110 is high, a shorter time window may be used, and if the usage rate of the elevator car 110 is low, a longer time window may be used. In other words, the time window for defining the predefined number or the most recent travels of the elevator car 110 may be a sliding time window triggered by last travel of the elevator car preceding the inoperable notification. The predefined constant number of the most recent travels of the elevator car 110 may for example be, but is not limited to, 5, 10, 15, 20, or any other constant number of the most recent travels of the elevator car 110. The varying number of the most recent travels of the elevator car 110 may vary for example depending on the usage rate of the elevator car 110 or some other factor.

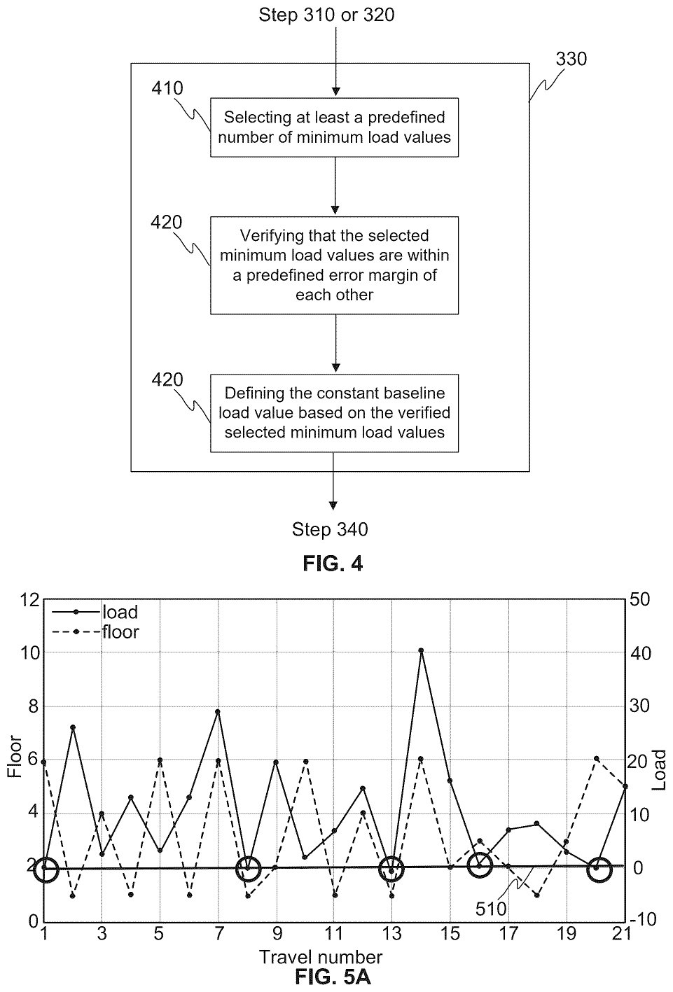

FIG. 4 illustrates schematically an example of the defining the constant baseline load value at the step 330.

At a step 410, the computing unit 210 selects a predefined number of minimum load values from among the observed load values of the predefined number of the most recent travels of the elevator car 110. The predefined number of minimum load values may for example be defined based on the predefined number of the most recent travels of the elevator car 110 and/or the usage rate of the elevator car 110. For example, if the predefined number of the most recent travels of the elevator car 110 is high, a higher number of minimum load values may be selected, and if the predefined number of the most recent travels of the elevator car 110 is low, a lower number of minimum load values may be selected. According to a non-limiting example, if the predefined number of the most recent travels of the elevator car 110 is 20, five minimum load values may be selected from among the observed load values of the predefined number of the most recent travels of the elevator car 110.

At a step 420, the computing unit 210 verifies that the selected minimum load values are within a predefined error margin of each other. At least some error margin between the selected minimum load values may need to be allowed because some natural variation may be observed with a constant load of the elevator car 110. If one or more of the selected minimum load values are not within the predefined error margin of the other selected minimum load values, said one or more load values may be removed from the selected minimum load values.

At a step 430, the computing unit 210 defines the constant baseline load value based on the verified selected minimum load values. The constant baseline load value may for example be defined based on the verified selected minimum load values by using statistics. For example, the constant baseline load value may be an average, e.g. an arithmetic mean, of the verified selected minimum load values. The constant baseline load value enables defining a mass caused by one or more non-human objects, e.g. goods, inside the elevator car 110.

At a step 340, the computing unit 210 compares the load value of the last travel of the elevator car 110 to the constant baseline load value defined at the step 330.

At a step 350, the computing unit 210 detects the entrapment situation inside the elevator car 110, if the result of the comparing, i.e. the comparison, at the step 340, indicates that the load value of the last travel is substantially greater than the constant baseline load value. In other words, if the load value of the last travel of the elevator car 110 is substantially greater than the constant baseline load value, it indicates that there may be one or more human objects 160 entrapped inside the elevator car 110 after the last travel of the elevator car 110. This, especially the use of the defined constant baseline load value, enables recognizing whether there are one or more human objects, e.g. passengers, 160 entrapped inside the elevator car 110. The expression “substantially greater” in context of the comparison of the load value of the last travel and the constant baseline load value at the step 350 may for example mean that the load value of the last travel of the elevator car 110 is greater than the constant baseline load value by at least a predefined threshold value. The predefined threshold value may for example be defined based on an estimation of a minimum load representing an estimation of a minimum mass of a human object. Alternatively or in addition, the predefined threshold value may for example be defined based on the error margin used in the verification step 420 of the selected minimum load values, e.g. so that the predefined threshold value may be defined to be at least greater than the error margin.

At a step 360, in response to detecting the entrapment situation inside the elevator car 110 at the step 350, the computing unit 210 may generate at least one service need, e.g. a maintenance need. The at least one service need may comprise an indication of the detected entrapment situation inside the elevator car 110. The at least one service need may for example be generated to service personnel, e.g. maintenance personnel, to inform the service personnel about the entrapment situation and for evacuating the passengers 160 entrapped inside the elevator car 110. If the telemetry message of the last travel of the elevator car 110 comprises further the stopping location of the elevator car 110, the stopping location may for example be comprised in the service need to guide the service personnel to the correct location to evacuate the passengers entrapped inside the elevator car 110.

According to an example, the load values comprised in the obtained telemetry messages may further be used to define a human object empty load value of the elevator car 110 representing the load of the elevator car 110 being empty of human objects 160. If the load value comprised in one of the obtained telemetry messages is below the defined constant baseline load value by a value distinctly exceeding the error margin, it indicates that one or more non-human objects previously resided inside the elevator car 110 have been removed from the elevator car 110. In that case said load value being below the defined constant baseline load value by the value distinctly exceeding the error margin may be set, e.g. by the computing unit 210, as the human object empty load value. According to a non-limiting example, if the error margin is +3 kg and the load value of the elevator car 110 comprised in one of the obtained telemetry messages is for example 10 kg below the defined constant baseline load value, which indicates that one or more non-human objects previously resided inside the elevator car 110 have been removed from the elevator car 110, the computing unit 210 may set said load value of the elevator car 110 as the human object empty load value. The defining of the human object empty load value of the elevator car 110 based on the load values comprised in the obtained telemetry messages is especially beneficial, if the constant baseline load value is defined over a long-term period, e.g. the time window for the definition of the constant baseline load value is long.

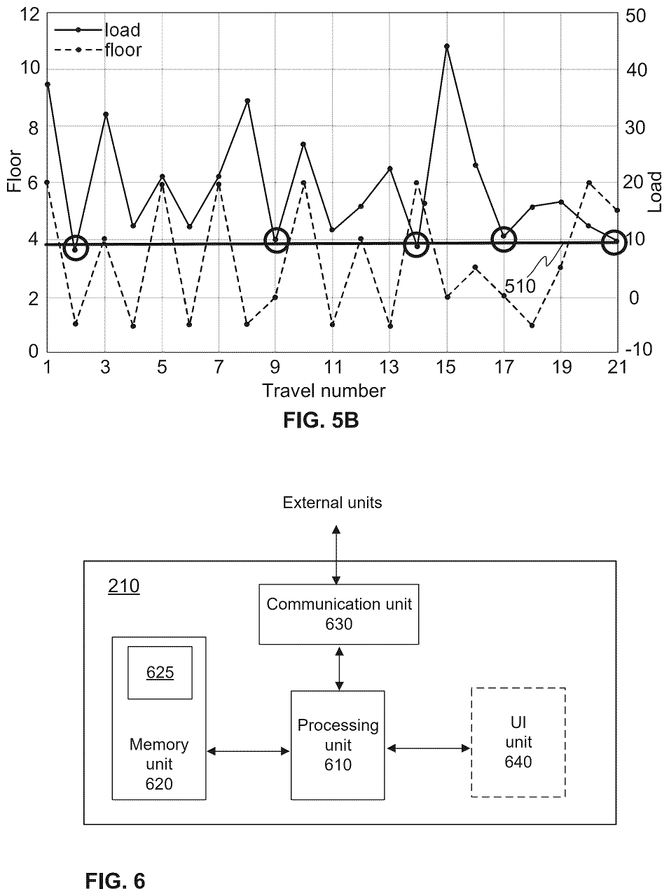

FIGS. 5A and 5B illustrate schematically examples of obtained telemetry messages of the predefined number of the most recent travels of the elevator car 110, wherein each telemetry message is obtained after one travel of the elevator car 110. In the examples of FIGS. 5A and 5B, each telemetry message comprises the load value (solid line) and the stopping location of said travel of the elevator car 110 (dashed line). The load value is the load of the elevator car 110 expressed as percentages of the nominal load of the elevator car 110. The stopping location is expressed as floor numbers. In case the destination floor has been reached at the end of the travel of the elevator car 110, the stopping location is the destination floor of said travel of the elevator car 110. In case the elevator car 110 has not been reached the destination floor at the end of the travel of the elevator car 110, e.g. the elevator car 110 has been stopped between two consecutive floors, the stopping location is between said two consecutive floors. In the examples of FIGS. 5A and 5B, the predefined number of the most recent travels of the elevator car 110 is 21 belonging the last travel of the elevator car 110, i.e. the 21st travel of the elevator car 110 in these examples.

In the example of FIG. 5A, the predefined number of minimum load values selected from among the observed load values of the predefined number of the most recent travels of the elevator car 110 is 5. These five selected minimum number values (in percent of the nominal load of the elevator car 110) are 0 (travel 1), 0 (travel 8), −1 (travel 13), 0 (travel 16), and 0 (travel 20). The selected minimum number values are illustrated with circles in FIG. 5A. In this example the predefined error margin may be ±1, which means that all the selected five minimum number values are the predefined error margin within each other. Thus, in this example the constant baseline load value 510 is 0, which is the average of the verified selected minimum load values rounded to the nearest integer. The constant baseline load value 510 being close to 0 percent of the nominal load of the elevator car 110 indicates that the elevator car 110 is empty of the constant load, i.e. non-human objects, such as goods, constantly inside the elevator car 110 (i.e. during all the predefined number of travels of the elevator car 110). In this example the load value of the last travel of the elevator car 110 (travel 21) is 15, which is substantially greater than the constant baseline load value 510. This in turn indicates that there might be one or more human objects 160 inside the elevator car 110 and thus the computing unit 210 detects the entrapment situation inside the elevator car 110 and may generate the at least one service need.

In the example of FIG. 5B, the predefined number of minimum load values selected from among the observed load values of the predefined number of the most recent travels of the elevator car 110 is 5. These five selected minimum number values are (in percent of the nominal load of the elevator car 110) 8 (travel 2), 10 (travel 9), 8 (travel 14), 11 (travel 17), and 10 (travel 21). The selected minimum number values are illustrated with circles in FIG. 5B.

In this example the last travel of the elevator car 110 (travel 21) is included also in the selection of the predefined number of minimum load values from among the observed load values of the predefined number of the most recent travels of the elevator car 110. However, the last travel of the elevator car 110 may be excluded from the selection of the predefined number of minimum load values. In this example the predefined error margin may be ±3, which means that all the selected five minimum number values are the predefined error margin within each other. Thus, in this example the constant baseline load value 510 is 9, which is the average of the verified selected minimum load values rounded to the nearest integer. The constant baseline load value 510 being above 0 percent of the nominal load of the elevator car 110 indicates that there is the constant load, i.e. non-human objects, such as goods, constantly inside the elevator car 110 (i.e. during all the predefined number of travels of the elevator car 110). In this example the load value of the last travel of the elevator car 110 (travel 21) is 9, which is not substantially greater than the constant baseline load value 510. This in turn indicates that most likely there is no human objects 160 inside the elevator car 110 and thus the computing unit 210 does not end up into the detection of the entrapment situation inside the elevator car 110.

FIG. 6 illustrates schematically an example of components of the computing unit 210. The computing unit 210 may comprise a processing unit 610 comprising one or more processors, a memory unit 620 comprising one or more memories, a communication unit 630 comprising one or more communication devices, and possibly a user interface (UI) unit 640. The mentioned elements may be communicatively coupled to each other with e.g. a communication bus. The memory unit 620 may store and maintain portions of a computer program (code) 625, and data, e.g. the content of the obtained telemetry messages or any other data. The computer program 625 may comprise instructions which, when the computer program 625 is executed by the processing unit 610 of the computing unit 210 may cause the processing unit 610, and thus the computing unit 210 to carry out desired tasks, e.g. one or more of the method steps described above described above. The processing unit 610 may thus be arranged to access the memory unit 620 and retrieve and store any information therefrom and thereto. For sake of clarity, the processor herein refers to any unit suitable for processing information and control the operation of the computing unit 210, among other tasks. The operations may also be implemented with a microcontroller solution with embedded software. Similarly, the memory unit 620 is not limited to a certain type of memory only, but any memory type suitable for storing the described pieces of information may be applied in the context of the present invention. The communication unit 630 provides one or more communication interfaces for communication with any other unit, e.g. the elevator control system 140, the connectivity module, the remote monitoring system 220, one or more databases, or with any other unit. The user interface unit 640 may comprise one or more input/output (I/O) devices, such as buttons, keyboard, touch screen, microphone, loudspeaker, display and so on, for receiving user input and outputting information. The computer program 625 may be a computer program product that may be comprised in a tangible nonvolatile (non-transitory) computer-readable medium bearing the computer program code 625 embodied therein for use with a computer, i.e. the computing unit 210.

The specific examples provided in the description given above should not be construed as limiting the applicability and/or the interpretation of the appended claims. Lists and groups of examples provided in the description given above are not exhaustive unless otherwise explicitly stated.

1. A method for detecting an entrapment situation inside an elevator car, the method comprising:
obtaining a telemetry message after a configurable number of travels of the elevator car, wherein each telemetry message comprises load values representing load of the elevator car during the configurable number of travels of the elevator car;
observing the load values of a predefined number of the most recent travels of the elevator car to define a constant baseline load value representing the load of the elevator car without human objects inside it;
comparing the load value of the last travel of the elevator car to the constant baseline load value; and
detecting the entrapment situation inside the elevator car, if the result of the comparing indicates that the load value of the last travel is substantially greater than the constant baseline load value.

2. The method according to claim 1, further comprising generating at least one service need comprising an indication of the detected entrapment situation inside the elevator car.

3. The method according to any of the preceding claims, wherein the load value comprises a mass of the load of the elevator car or a parameter representing the mass of the load of the elevator car.

4. The method according to claim 3, wherein the parameter comprises power data representing electrical power supplied to a hoisting motor configured to move the elevator car, torque and current data representing torque and current of the hoisting motor during a constant speed phase of the travel of the elevator car, or energy data representing accumulated power supplied to the hoisting motor during the travel of the elevator car.

5. The method according to claim 1, wherein each telemetry message further comprises stopping location data representing locations in an elevator shaft, where the elevator car has stopped at the end of the configurable number of travels of the elevator car.

6. The method according to claim 1, further comprising:
receiving an inoperable notification indicating an inoperable condition of the elevator car; and
observing the load values of the predefined number of the most recent travels of the elevator car to define the constant baseline load value representing the load of the elevator car without human objects inside it, in response to receiving the inoperable notification.

7. The method according to claim 6, wherein the inoperable notification is a fault telemetry message comprising a fault notification indicating the inoperable condition of the elevator car.

8. The method according to claim 1, wherein the predefined number of the most recent travels of the elevator car is defined based on a certain time window preceding the last travel of the elevator car, a predefined constant number of the most recent travels of the elevator car, or a varying number of the most recent travels of the elevator car.

9. The method according to claim 1, wherein the defining the constant baseline load value comprises:
selecting at least a predefined number of minimum load values from among the observed load values of the predefined number of the most recent travels of the elevator car;
verifying that the selected minimum load values are within a predefined error margin of each other; and
defining the constant baseline load value based on the verified selected minimum load values.

10. A computing unit for detecting an entrapment situation inside an elevator car, the computing unit comprises:
a processing unit comprising one or more processors, and
a memory unit comprising one or more memories storing a computer program code,
wherein one or more memories and the computer program code are configured to, with the one or more processors, cause the computing unit to perform:
obtain a telemetry message after a configurable number of travels of the elevator car, wherein each telemetry message comprises load values representing a load of the elevator car during the configurable number of travels of the elevator car;
observe the load values of a predefined number of the most recent travels of the elevator car to define a constant baseline load value representing the load of the elevator car without human objects inside it;
compare the load value of the last travel of the elevator car to the constant baseline load value; and
detect the entrapment situation inside the elevator car, if the result of the comparing indicates that the load value of the last travel is substantially greater than the constant baseline load value.

11. The computing unit according to claim 10, further configured to generate at least one service need comprising an indication of the detected entrapment situation inside the elevator car.

12. The computing unit according to claim 10, wherein the load value comprises a mass of the load of the elevator car or a parameter representing the mass of the load of the elevator car.

13. The computing unit according to claim 12, wherein the parameter comprises power data representing electrical power supplied to a hoisting motor configured to move the elevator car, torque and current data representing torque and current of the hoisting motor during a constant speed phase of the travel of the elevator car, or energy data representing accumulated power supplied to the hoisting motor during the travel of the elevator car.

14. The computing unit according to claim 10, wherein each telemetry message further comprises stopping location data representing a location in an elevator shaft, where the elevator car has stopped at the end of said travel of the elevator car.

15. The computing unit according to claim 10, further configured to:
receive an inoperable notification indicating an inoperable condition of the elevator car;
observe the load values of the predefined number of the most recent travels of the elevator car to define the constant baseline load value representing the load of the elevator car without human objects inside it, in response to receiving the inoperable notification.

16. The computing unit according to claim 15, wherein the inoperable notification is a fault telemetry message comprising a fault notification indicating the inoperable condition of the elevator car.

17. The computing unit according to claim 10, wherein the predefined number of the most recent travels of the elevator car is defined based on a certain time window preceding the last travel of the elevator car, a predefined constant number of the most recent travels of the elevator car, or a varying number of the most recent travels of the elevator car.

18. The computing unit according to claim 10, wherein the defining the constant baseline load value comprises that the computing unit is configured to:
select at least a predefined number of minimum load values from among the observed load values of the predefined number of the most recent travels of the elevator car;
verify that the selected minimum load values are within a predefined error margin of each other; and
define the constant baseline load value based on the verified selected minimum load values.

19. A detection system for detecting an entrapment situation inside an elevator car, the detection system comprises:
an elevator control system, and
a computing unit according to claim 10.
